(19) United States
(12) Patent Application Publication
(10) Pub. No.: US 2017/0129435 A1
(43) Pub. Date: May 11, 2017

(54) VEHICLE COMMUNICATION SYSTEM, VEHICLE, COMMUNICATION SYSTEM AND METHOD FOR PROCESSING VEHICLE CRASH DATA

(71) Applicant: GM GLOBAL TECHNOLOGY OPERATIONS LLC, Detroit, MI (US)

(72) Inventor: Stephane VITET, Ruesselsheim (DE)

(73) Assignee: GM GLOBAL TECHNOLOGY OPERATIONS LLC, Detroit, MI (US)

(21) Appl. No.: 15/348,442

(22) Filed: Nov. 10, 2016

(30) Foreign Application Priority Data
Nov. 11, 2015 (GB) 1519903.7

(51) Int. Cl. B60R 21/0136; B60R 21/015

(52) U.S. Cl. CPC B60R 21/0136; B60R 21/01512; B60R 21/01558; B60R 21/01516; B60R 21/01546; B60R 2021/0027

(57) ABSTRACT

A vehicle communication system for a vehicle is described with at least one crash sensor configured to recognize a crash of the vehicle. A passenger recognition system recognizes the number and/or location of passengers in the vehicle. A controller is connected to the at least one crash sensor, the passenger recognition system and a transmitter and configured to generate crash information using crash sensor readout. The controller is further configured to generate a data set including the crash information and number and/or location of passengers in the vehicle from the passenger recognition system. A transmitter is configured to send the data set.

### CROSS-REFERENCE TO RELATED APPLICATION

This application claims priority to Great Britain Patent Application No. 1519903.7, filed Nov. 11, 2015, which is incorporated herein by reference in its entirety.

### TECHNICAL FIELD

The present disclosure pertains to a vehicle communication system, a vehicle, a communication system and a method for processing vehicle crash data will be described.

### BACKGROUND

Vehicles are widely used for transportation purposes. They carry people and cargo over differing terrain in a variety of conditions. Unfortunately, in the process of performing their function, vehicles may be involved in a collision or crash. Often, public safety personnel, such as emergency responders, are called on to assist vehicle passengers when a crash occurs. However, the severity of vehicle crashes can vary from low speed collisions to crashes involving much higher speed and momentum. Before emergency responders arrive on the scene, they may not know whether the vehicle collision is best described by the former situation or the latter. Even if the emergency responders have information relating to the vehicle crash it may be incomplete or inaccurate. Therefore, it may be helpful to provide additional information relating to the vehicle collision and supply that information to emergency responders before they arrive at the crash site.

Increased connectivity of vehicles via telecommunication systems provides new options for increasing travel safety. For example, the system known as “Onstar®” is capable of transmitting relevant vehicle data to a control center if a vehicle crash is detected. The detection of the crash can, for example, be accomplished via a deployed airbag. The transmitted vehicle data can include position, driving direction, vehicle color and severity of the crash. Further, a call can be established to connect a control center member to the passengers of the crashed vehicle. This allows for rapidly sending an emergency responder team to the crash scene. The time between crash and appearance of the emergency responder team can be significantly shortened, increasing likelihood of survival of the passengers.

U.S. Pat. No. 8,749,350B2 discloses a method of processing vehicle crash data, including: wirelessly receiving at a control center vehicle data obtained from one or more vehicle modules at a vehicle during a vehicle crash; determining the identity of the vehicle at the control center using one or more databases; estimating the severity of the vehicle crash using the determined vehicle identity and the received vehicle data, wherein the estimating step is at least partly carried out using the control center or a computer; graphically depicting the estimated severity of the vehicle crash on a wireless device used by an emergency responder via a plurality of shaded sections that each identity and locate a particular vehicle component, wherein each of at least some shaded sections are denoted with a different color.

For an efficient rescue it would be helpful to send a sufficient number of emergency responders with proper training and equipment to the crash site. The required number of emergency responders and their required training can depend on the severity of the crash and the number of involved passengers. The known systems can only provide rough predictions.

Accordingly, there is a need to improve vehicle communication systems, vehicles, communication systems and methods for processing vehicle crash data such that a better prediction of the necessary number of emergency responders is possible.

### SUMMARY

Accordingly, the present disclosure described a vehicle communication system for a vehicle with at least one crash sensor configured to recognize a crash of the vehicle. A passenger recognition system recognizes the number and/or location of passengers in the vehicle. A controller is connected to the at least one crash sensor, the passenger recognition system and a transmitter. The controller and/or the at least one crash sensor are configured to generate crash information using crash sensor readout. The controller is further configured to generate a data set including the crash information and number and/or location of passengers in the vehicle from the passenger recognition system. The transmitter is configured to send the data set.

The vehicle communication system can automatically transmit a message to a recipient that the respective vehicle including the vehicle communication system was involved in a crash. The message can contain information about the number of passengers and/or of their location in the car, i.e. which seats the passengers occupy. The respective vehicle communication system facilitates an assessment of how many potentially injured persons might be involved in the crash. Consequently, a suitable number of emergency responders with appropriate qualification and equipment, including medical professionals, can be sent to the crash scene.

In a first embodiment, the controller can be configured to append crash severity information to the data set. This can be accomplished by quantitatively reading out the crash sensor data. The read out can contain information about accelerations caused by the crash, impact location, relative impact direction etc. With this, different crash scenarios can be distinguished from each other. For example, a side impact with a certain momentum leads to a different severity than a front impact with the same momentum. This allows for an increased precision in the assessment about the required number and equipment of the emergency responders.

In a further embodiment, the passenger recognition system includes at least one seat occupancy sensor and/or at least one belt buckle sensor. The use of seat occupancy sensors and/or belt buckle sensors allows for recognition of the occupancy status of a given seat. Seat occupancy sensors can be built in various different ways, including switches actuated by the weight of the passenger, capacitive sensors, temperature sensors and the like. A switch could be designed in a way that it is only actuated above certain weight threshold. Belt buckle sensors can be built into a seat belt lock and can be implemented as switches, hall sensors, circuits etc. A locked seat belt is an indicator that a passenger is occupying the seat.

Different seats in the car might be equipped differently. For example, some vehicles might include both, seat occupancy sensors and belt buckle sensors for all seats. Some vehicles might include both sensors in the front seats and just belt buckle sensors in the back seat row(s). If a certain seat is equipped with both, seat occupancy sensor and belt buckle sensor, a logic device could decide if the seat is taken if the respective sensors show an inconsistent result. The calculation of the overall number of passengers and/or their location in the vehicle can use the readout of respective aforementioned sensors and common logic, for example that the driver seat will always be occupied. With that a very high accuracy of the prediction is possible.

In a further embodiment the seat occupancy sensor is a pressure sensor. The pressure sensor can determine the force exerted on a respective seat and therefore the weight of the passenger. With this, adults can be distinguished from children and in some embodiments even children from babies.

In another embodiment the at least one crash sensor can include an acceleration sensor. An acceleration sensor can detect an acceleration effected by the crash. The acceleration can be used to estimate the severity of an impact. Amongst others, direction, location and amount of the acceleration are values that can be used for the severity estimation. In some embodiments, more than one acceleration sensor could be used in the system. The acceleration sensors could be used for differential measurements so that a precise estimation of the kind and severity of the crash is possible. For example, a front crash will lead to higher accelerations in the front of the vehicle than in the back.

In another embodiment, the vehicle communication system includes a position recognition system, wherein the controller is connected to the position recognition system, the controller being configured to append crash location information to the data set. Such a position recognition system can be a GPS system. The system can be part of a navigation system. In some embodiments, in particular if the position recognition system is part of a navigation system, also the driving direction can be detected through the position recognition system.

In a further embodiment, the controller is connected to a memory, the memory containing information on vehicle type, number of seats, vehicle ID, location of the vehicle, driving direction, number of crash incidents, number of passengers in the vehicle, type of passengers in the vehicle, location of passengers in the vehicle, speed of the vehicle and/or vehicle door actuation. All this information is useful for determining the required number and qualification of first responders. For example, if more than one crash event is detected, this can be interpreted as a sign of a crash with at least three involved vehicles. More first responders would then be required at the crash scene. The remaining information can also be useful to gain a more precise assessment of the crash.

In another embodiment, at least one door sensor connected to the control is provided, wherein the controller is configured to transmit information about door actuations in temporal relation to the crash. This makes it possible to determine whether passengers have left the vehicle after the crash or whether other first responders may already be at the crash scene. For this purpose, it may be provided that the door sensor can differ between external and internal door actuations.

In another further embodiment, the communication system may include a separate power supply for the operation of the controller and the transmitter. In this way, even when the power supply of the electrical system has collapsed due to the crash, a corresponding data set can be transmitted.

A first independent aspect relates to a vehicle with a vehicle communication system according to any embodiment of the preceding description. A corresponding vehicle can transmit information about the number of passengers in the vehicle and the severity of the crash directly after the crash occurred.

A second independent aspect relates to a communication system including a vehicle according to the preceding aspect and a control center, the control center including a receiver for receiving the data set, the control center including a data processor, the data processor being configured to read out the number and/or location of passengers in the vehicle from the data set. The control center can obtain information about the crash from the vehicle, evaluate and send a corresponding number of first responders with appropriate qualification to the crash.

In another embodiment, the data processor is configured to read out crash sensor information included in the data set and to calculate a severity of the crash of the vehicle. In further embodiment, the data processor is connected to a data base containing passenger and crash specific severity information. The data processor is configured to calculate a severity of a potential injury per passenger. The potential injury of a passenger might depend on the passenger location. For example, in a front crash situation, rear seat passengers have a lower risk of injury than front seat passengers.

A third independent aspect relates to a method of processing vehicle crash data. A number and/or location of passengers in a vehicle are identified using a passenger recognition system. Crash information is collected from at least one crash sensor. The crash information and the passenger information are combined into a data set. The data set is sent via a transmitter which may be received via a receiver in a control center and processed on a data processor.

In a first embodiment, the number and/or location of passengers in the vehicle are identified using belt buckle sensor information and/or seat occupancy sensor information. In another embodiment, the number and/or location of passengers are identified using logics. The logic can be that the driver seat is always occupied or the number of passengers cannot be higher than the number of seats the vehicle includes. The logics can also use exclusion criteria like if a seat belt is fastened but no weight is recognized in the respective seat, the seat will not be counted.

In another embodiment, a crash severity per passenger is estimated using information on number and position of passengers and vehicle crash information. This leads to an improved prediction about how many and which emergency rescuers are required and how they should be equipped.

In a further embodiment, the crash severity per passenger is estimated using a data base. The data base can classify certain types and severities of crashes and the risk of injury per seat and, in some embodiments, per passenger type (adult or children). The data base gives a good forecast of the potential level and type of injury per person.

In another embodiment, the result of the processing of the data set is forwarded to an emergency responder coordination center. The emergency responder coordination center can be in local proximity to the crash scene, whereas the control center could be very remote.

A fourth independent aspect relates to an apparatus for processing vehicle crash data. A passenger recognition system identifies a number and/or location of passengers in a vehicle using data processor to collect crash information from at least one crash sensor and to combine the crash information and the passenger information into a data set. A transmitter sends the data set to a receiver in a control center configured to receive the data set. A data processor processes the data set.

In a first embodiment, the system includes a belt buckle sensor and/or a seat occupancy sensor for identifying the number and/or location of passengers in the vehicle. In another embodiment, logic means are provided to identify the number and/or location of passengers.

In a further embodiment, a crash severity estimation estimates a severity of the crash using information on number and position of passengers and vehicle crash information. In yet another embodiment, a data base is provided to estimate the crash severity per passenger.

In a further embodiment, the result of processing the data set is forwarded to a rescue coordination center.

### BRIEF DESCRIPTION OF THE DRAWINGS

The present disclosure will hereinafter be described in conjunction with the following drawing figures, wherein like numerals denote like elements.

FIG. 1 is a plan view of a vehicle with a vehicle communication system;

FIG. 2 shows a communication system with the car of FIG. 1; and

FIG. 3 is a flow chart of the transmittal of a data set to a coordination center.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

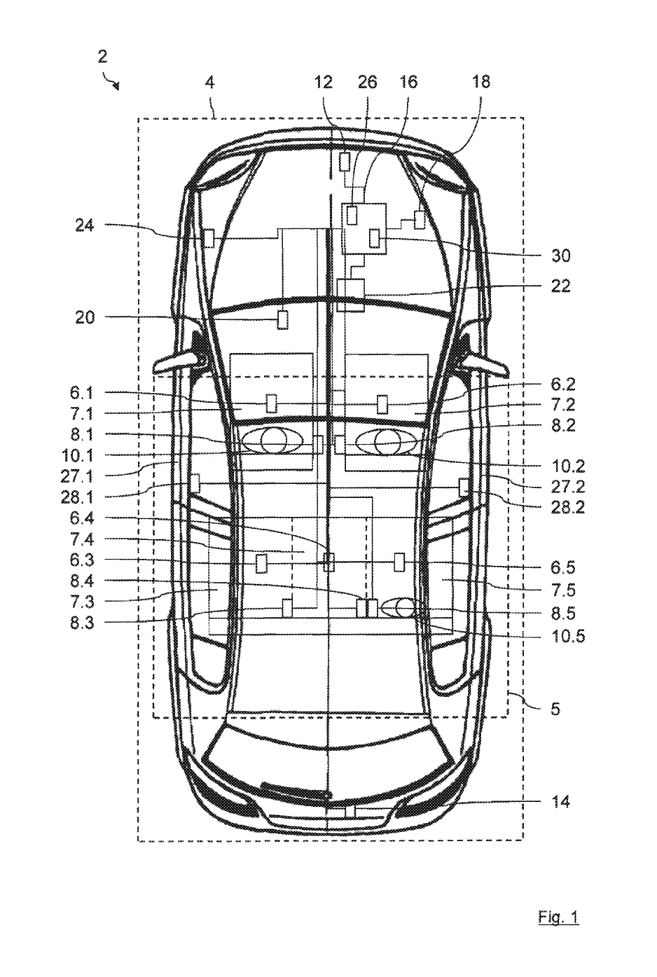

FIG. 1 shows a plan view of a vehicle 2 with a vehicle communication system 4 (dashed frame). For detection of passengers, the vehicle communication system 4 includes a passenger recognition system 5 with seat occupancy sensors 6.1 to 6.5 on seats 7.1 to 7.5. The seat occupancy sensors 6.1 to 6.5 are pressure sensitive sensors. Thus, with the seat occupancy sensors 6.1 to 6.5, the weight of the passenger 10.1 to 10.3 sitting on the respective seat 7.1 to 7.5 can be estimated. Therefore, it can be discriminated whether the seat 7.1 to 7.5 is taken by an adult or a child. Furthermore, belt buckle sensors 8.1 to 8.5 are provided at the seats 7.1 to 7.7 for passenger detection. Three passengers are sitting in the vehicle 2: a driver 10.1 on front seat 7.1, an adult passenger 10.2 on front seat 7.2 and a child 10.3 on rear seat 7.5.

The vehicle communication system 4 assesses the number and location 7.1, 7.2, 7.5 of the passengers 10.1 to 10.3 in the vehicle 2 using a combination of a read-out of the sensors 6.1 to 6.5, 8.1 to 8.5 and logics. It is safe to assume that the driver seat is always occupied in a driving vehicle and that the number of passengers does not exceed the number of available seats. It is also safe to assume that a driver is always an adult. If a seat occupancy sensor detects very little pressure, this might be a result of a bag or the like standing on the seat. Further, simultaneous positive feedback from seat occupancy sensors 6.1 to 6.5 and belt buckle sensors 8.1 to 8.5 for a specific seat 7.1 to 7.5 in the vehicle 2 strongly suggests an occupation of the corresponding seat 7.1, 7.2, 7.5 with one passenger 10.1, 10.2, 10.3 each.

Furthermore, an acceleration sensor 12 is provided at the front of the vehicle 2 and an acceleration sensor 14 is provided at the rear of the vehicle 2. The acceleration sensors 12, 14 are built to detect high accelerations of the vehicle 2, for example, greater than 5 G, in order to distinguish a crash from normal acceleration.

Also, a controller 16 is provided. The controller 16 is connected to the seat occupancy sensors 6.1 to 6.5, the belt buckle sensors 8.1 to 8.5, the front acceleration sensor 12 and as well as the rear acceleration sensor 14.

The controller 16 is further connected to a transmitter 18. The controller 16 can send data sets via the transmitter 18. The controller 16 is also connected to an air bag sensor 20. The airbag sensor 20 identifies whether an airbag has been deployed. This is an indication that the vehicle 2 is involved in a crash. Instead of a separate airbag sensor 20, a correspondingly equipped vehicle control can be provided, which is informed of the air bag being deployed. The controller 16 may itself be part of the vehicle control.

The controller 16 is further connected to a navigation system 22. The navigation system 22 continuously determines the current location of the vehicle 2. This, the navigation system 22 can detect the temporal change of position of the vehicle 2 and draw conclusions about the direction of travel and speed. The speed can be determined as a wheel speed sensor 24.

The controller 16 is equipped with a memory 26 in which a plurality of information is permanently stored and can be temporarily stored. The memory 26 stores information about vehicle type and a vehicle ID. The vehicle ID may be represented, for example, by a serial number. The information stored in the memory 26 can also go beyond this and include, for example, a color of the vehicle. 2 The memory 26 may include the number of seats 7.1 to 7.5 in the vehicle. 2 The memory 26 further might store variable data as well as information on the current location of the vehicle 2, its speed and its driving direction which it can retrieve from the navigation system 22 and, partly, from the wheel speed sensor 24. Further variable data can include the number, type and location 7.1, 7.2, 7.5 of passengers 10.1, 10.2, 10.3 in the vehicle 2, which can be derived from evaluating the seat occupancy sensors 6.1 to 6.5 and belt buckle sensors 8.1 to 8.5 and possible door actuations of doors 27.1, 27.2.

The controller 16 is further connected to door sensors 28.1, 28.2. With the help of the door sensors 28.1, 28.2, actuation of a door 27.1, 27.2 of the vehicle 2 can be detected. If the doors 27.1, 27.2 have been actuated after a crash, the information can be used for assessing the situation.

In case of a crash of the vehicle 2, that can be identified via acceleration sensors 12, 14 and/or recognition of the firing of the airbag via the airbag sensor 20, the controller 16 retrieves information from the memory 26 on relevant crash data. The relevant crash data includes, amongst others, for example: type of the vehicle 2, vehicle identification number, vehicle color etc. Further, the controller 16 collects information about the severity of the crash, which is possible by reading out the acceleration sensors 12, 14. The controller 16 also identifies whether there have been multiple crash events in temporal relation, e.g. via a continuous read out of the acceleration sensors 12, 14, the current location of the vehicle 2 as well as number and location 7.1, 7.2, 7.5 of the passengers 10.1 to 10.3 in the vehicle 2. The controller 16 generates a data set with the aforementioned information. The data set is sent out using the transmitter 18. The data set can be sent to a control center which can inform first responders immediately.

The controller 16 is further equipped with a battery 30 to provide a self-sufficient energy supply of the controller 16 and the transmitter 18. This is helpful in the event that the electrical system of the vehicle 2 collapses.

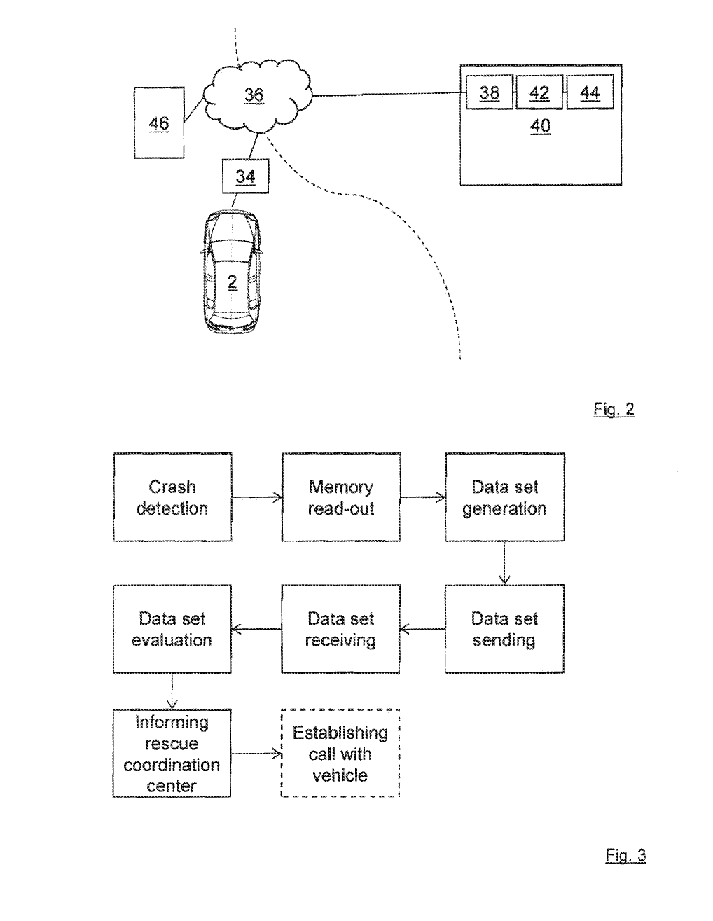

FIG. 2 shows a communication system 32 with the vehicle 2. As mentioned in connection with FIG. 1, the vehicle 2 transmits a data set 34 via the transmitter 18 in the event of a crash. The data set 34 contains information on vehicle type, number of seats 7.1 to 7.5 in the vehicle 2, the vehicle identification data, location of the vehicle, the direction of travel, number of crash events, number of passengers 10.1 to 10.3 in the vehicle 2, type of passengers 10.1 to 10.3 in the vehicle 2, speed of the vehicle 2 before the crash and/or door actuations of the doors 27.1, 27.2.

The data set 34 is transmitted, for example, via a network 36 and received by a receiver 38 of a control center 40. In the control center 40, the data set 34 can be analyzed using a data processor 42. The control center 40 it can send an appropriate number of first responders with required equipment and training.

The data processor 42 is connected to a data base 44. The data base 44 includes injury severity information for a number of different criteria, including for example type of vehicle 2, seat and passenger type related to the crash type, in particular location, direction and acceleration and/or momentum and/or force of the crash.

The analyzed information can be used to inform a rescue coordination center 46 near by the crash location and to inform them about the requirements in terms of number and qualification of emergency responders and their equipment.

FIG. 3 shows a flow chart of the method. Initially, a crash is detected by controller 16, for example via read-out of acceleration sensors 12, 14 or the airbag sensor 20. Subsequently, the information to be sent which was previously referred to is read out from the memory 26. The memory 26 receives periodic updates of the latest relevant data such as number of passengers 10.1 to 10.3 in the vehicle 2, current location, driving direction and speed.

The controller 16 generates a data set 34 and sends it via the transmitter 18. The data set 34 is received from the receiver 38 in the control center 40. In the control center 40, the data set 34 can be evaluated and processed using the data base 44. A rescue coordination center can be informed of the crash. Subsequently, in some embodiments, the control center 40 can establish a call to the vehicle 2, to see if the passengers 10.1 to 10.3 are responsive and if so, to obtain further information about the crash.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A vehicle communication system for a vehicle comprising:
at least one crash sensor configured to recognize a crash of the vehicle and generate a crash sensor readout;
passenger recognition system configured to recognize passenger data including at least one of a number or a location of passengers in the vehicle;
a transmitter configured to send a data set from the vehicle; and
a controller in communication with the at least one crash sensor, the passenger recognition system and the transmitter, wherein at least one of the controller or the at least one crash sensor being configured to generate crash information using the crash sensor readout and the controller is configured to generate the data set including the crash information and passenger date.

17. The vehicle communication system according to claim 16, wherein the passenger recognition system comprises at least one of a seat occupancy sensor or a belt buckle sensor.

18. The vehicle communication system according to claim 17, wherein the seat occupancy sensor comprises a pressure sensor.

19. The vehicle communication system according to claim 16, wherein the vehicle communication system comprises a position recognition system, wherein the controller is connected to the position recognition system and configured to append crash location information to the data set.

20. The vehicle communication system according to claim 16, wherein the controller is connected to a memory containing information selected from the group consisting of vehicle type, number of seats, vehicle ID, location of the vehicle, driving direction, number of crash incidents, number of passengers in the vehicle, type of passengers in the vehicle, location of passengers in the vehicle, speed of the vehicle, vehicle door actuation or a combination thereof.

21. A vehicle comprising a vehicle communication system according to claim 16.

22. A communication system comprising the vehicle communication system according to claim 16 and a control center comprising a receiver for receiving the data set, a data processor configured to read out the passenger data from the data set.

23. The communication system according to claim 22, wherein the data processor is configured to read out crash sensor information included in the data set and to calculate a severity of the crash of the vehicle.

24. The communication system according to claim 23, wherein the data processor is connected to a data base containing passenger and crash specific severity information, wherein the data processor is configured to calculate a severity of a potential injury per passenger.

25. A method of processing vehicle crash data, comprising the steps of:
identifying at least one of a number of passengers or a location of passengers in a vehicle using a passenger recognition system;
collecting crash information from at least one crash sensor;
combining the crash information and the passenger information into a data set;
sending the data set from the vehicle via a transmitter;
receiving the data set via a receiver in a control center; and
processing the data set via a data processor at the control center.

26. The method according to claim 25, wherein the number or location of passengers in the vehicle is identified using at least one of belt buckle sensor information or seat occupancy sensor information.

27. The method according to claim 25, wherein the number or location of passengers is identified using logics.

28. The method according to claim 25, further comprising estimating a crash severity per passenger using information on number and location of passengers and vehicle crash information.

29. The method according to claim 28, further comprising estimating a crash severity per passenger using a data base.

30. The method according to claim 25, further comprising forwarding the result of the processing of the data set to a rescue coordination center.
